(19) United States
(12) Patent Application Publication
(10) Pub. No.: US 2004/0175301 A1
(43) Pub. Date: Sep. 9, 2004

(54) Freewire system for suppression of particulate deposition and accumulation on processing chamber walls

(76) Inventors: Aaron D. Mao, Manteca, CA (US); Samuel L. Antonio, Manteca, CA (US); Pom Hyare, Tracy, CA (US)

Correspondence Address: ATMI, INC., 7 COMMERCE DRIVE, DANBURY, CT, 06810, US

(21) Appl. No.: 10/379,850

(22) Filed: Mar. 5, 2003

(51) Int. Cl. B01D 50/00

(52) U.S. Cl. 422/171; 15/246.5; 422/172

(57) ABSTRACT

Particulate deposition and accumulation is suppressed in a process chamber arranged for flow of gas therethrough, and including a gas-contacting surface, wherein the gas is susceptible to the presence or generation of particulate solids. A motive driver is arranged to provide a rotational driven movement output and is coupled to a flexible, elongate abrading element that has a free end disposed in the process chamber so that upon rotation by the motive driver, the abrading element engages the gas-contacting surface to abradingly remove particulate solids therefrom.

### FIELD OF THE INVENTION

The present invention relates to the suppression of particulate deposition and accumulation in process chambers susceptible to such deposition and accumulation, e.g., an oxidation reactor vessel for the abatement of toxic and hazardous materials in the treatment of effluent streams from semiconductor manufacturing operations.

### DESCRIPTION OF THE RELATED ART

In many industrial processes in which gaseous streams are flowed through system vessels and flow circuitry, there is susceptibility for deposition of particulates that can agglomerate or aggregate on the walls of the chamber and deleteriously affect the system operation. The particulates can be formed in situ in the process system or can be entrained in the gaseous stream being flowed through the specific chamber or condense from the gaseous stream, or be formed or present in other ways.

The deposits can build up by agglomeration or aggregation of the individual deposited particles and severely affect the structural integrity of the process chamber, e.g., by a corrosive or reactive character with respect to the chamber materials of construction. The deposits can have a sufficient build rate as to alter the conductance of the chamber and thereby alter pressures and flow rates of gaseous stream(s) flowed therethrough from their set point or desired values, so that the processing operation being carried out is rendered inefficient or even defective for its intended purpose. The deposits can in some instances be formed or present under severe processing conditions such as highly elevated temperatures and/or pressures, and subsequently be difficult or incapable of removal under ambient conditions under which system maintenance and cleaning is conducted. In the extreme, the particulate deposition can cumulatively create built-up layers of deposited material that are not readily and practically removed, and that render the process chamber useless for further operation.

An example of the above-discussed particulate deposition-susceptible process systems is the use in semiconductor manufacturing facilities of controlled decomposition oxidizers for the abatement of low-k material effluents. Effluents containing low-k material source reagents, such as trimethylsilane, tetramethylsilane, octamethylcyclotetrasiloxane (OMCTS), dimethyldimethoxysilane (DMDMOS) and 1,3,5,7-tetramethylcyclotetrasiloxane (TMCTS) are abated by oxidation treatment with oxygen or an oxygen-containing gas mixture in an oxidation reaction chamber, and such oxidation treatment produces very fine silicon dioxide (SiO₂) particles. These silicon dioxide particles deposit and collect on the reactor walls, and eventually restrict the flow of process gases.

Prior approaches to such particulate deposition have included the provision of “blanket” flows of inert liquids or gases along the reactor wall, which thereby shroud the interior wall surface of the reactor and sweep the particulates downstream in the gas flow stream so that the gas flow stream can be passed through a bag filter, electrostatic precipitator or other solids collection device or assembly. Other approaches have included a variety of inlet designs for the reactor vessel, which preferentially channel the gas flows through a central portion of the reactor vessel and/or induce turbulence in the gas adjacent the interior wall surfaces of the reactor, to minimize particle/wall interactions.

None of these approaches has been fully satisfactory. The arrangements in which shrouding fluids are flowed along interior wall surfaces of the reactor require hydrodynamic uniformity of the gas flow, as well as a constant ratio of volumetric flow rate of shrouding fluid to the volumetric flow rate of process (e.g., effluent and oxidant) gases, in order to provide a “perfect curtain” of fluid for reactor wall protection. This is very difficult to achieve, and any variation of pressure or flow rate fluctuation of any of the component process gases or shrouding fluids, will introduce a perturbation that can alter the level of protection of the wall surfaces and permit adherence of particulates on the reactor wall surface. Likewise, the approach of inducing local turbulence at the wall surface to minimize deposition is problematic, in that it is generally difficult to reconcile the residence time needed for treatment of the effluent stream with the flow velocities needed for induction of turbulence, and any pressure or flow variations can perturb the flow patterns in the reactor and lead to occurrence of particle deposition due to preferential flow channeling or other aberrant flow phenomena.

Accordingly, the art is in need of improved means and/or method for suppressing the deposition of particulates on wall surfaces of process chambers.

### SUMMARY OF THE INVENTION

The present invention relates to the suppression of particulate deposition and accumulation in process chambers susceptible to such deposition and accumulation.

In one aspect, the present invention relates to a process system comprising:

(a) a process chamber arranged for flow of gas therethrough, and including a gas-contacting surface, wherein the gas is susceptible to the presence or generation of particulate solids;

(b) a motive driver arranged to provide a rotational driven movement output; and

(c) a flexible, elongate abrading element, free-ended at a first end thereof and coupled at a second end thereof to the motive driver, for rotational driven movement of the abrading element so that the abrading element engages said gas-contacting surface during said rotational driven movement to abradingly remove particulate solids therefrom.

In another aspect, the invention relates to a method of suppressing solids build-up in a process chamber arranged for flow of gas therethrough, and including a gas-contacting surface, wherein the gas is susceptible to the presence or generation of particulate solids, said method comprising rotationally driving a flexible, elongate abrading element at one end thereof, wherein the flexible, elongate abrading element is free-ended at its opposite end, so that the abrading element engages said gas-contacting surface during rotational driven movement to abradingly remove solids therefrom.

Other aspects, features and embodiments of the invention will be more fully apparent from the ensuing disclosure and appended claims.

### BRIEF DESCRIPTION OF THE DRAWINGS

FIG. 1 is a schematic representation of a process system according to one embodiment of the invention.

### DETAILED DESCRIPTION OF THE INVENTIONS AND PREFERRED EMBODIMENTS THEREOF

The present invention is based on the discovery that a free-ended wire or other flexible, elongate abrading element coupled at an end thereof opposite its free end to a rotational driver can be used as a motive surface scraper on a gas-contacting surface of a process chamber, to suppress deposition and accumulation of solids on such surface. The invention therefore contemplates a process system comprising:

(a) a process chamber arranged for flow of gas therethrough, and including a gas-contacting surface, wherein the gas is susceptible to the presence or generation of particulate solids;

(b) a motive driver arranged to provide a rotational driven movement output; and

(c) a flexible, elongate abrading element, free-ended at a first end thereof and coupled at a second end thereof to the motive driver, for rotational driven movement of the abrading element so that the abrading element engages said gas-contacting surface during said rotational driven movement to abradingly remove particulate solids therefrom.

The flexible, elongate abrading element can be of any suitable type, and in a preferred embodiment comprises a simple wire article.

The flexible, elongate abrading element can for example include a wire, fiber, filament, cord, strand, ribbon, chain (linked or otherwise segmented article), whip, or other elongate member that is deployed in a free-end arrangement, with an opposite end coupled with a rotational drive so that a particulate deposition-susceptible surface in proximity to the abrading element is whipped by the abrading element, to remove deposited particles on such surface and suppress solids build-up thereon.

The flexible, elongate abrading element can be of any suitable diameter and length for its intended purpose, and can be formed of any suitable material(s) of construction, e.g., metals (e.g., copper, aluminum, iron, nickel, etc.), metal alloys (steel, brass, bronze, cobalt-nickel alloys, etc.), plastics and polymeric materials, natural fibers, composites, etc. The wire is advantageously formed of a material that flexes and bends when the wire is translated by the motive driver, e.g., an electric motor, pneumatically driven motor, hydraulically driven motor, fuel-powered engine, flywheel, armature, gearing, induction motor, magnetically coupled driver, generator, power take-off device, etc.

The abrading element can have any suitable diameter and length dimensions. In application to a cylindrical process chamber, the abrading element desirably is somewhat longer, e.g., 20-50% longer, than the longitudinal dimension of the process chamber, so as to maximize the “reach” of the abrading element to the entire interior surface of the process chamber. Conformationally, the abrading element can be linear or non-linear in character, and if of a non-linear conformation in which at least part of the abrading element is shaped in a curvate, spiraled, or helical fashion, or with some other non-linear shape, as may be necessary or desirable in a given application of the invention. The specific length, diameter and springiness/resilience characteristics can be readily selected and/or determined to achieve desirable surface-contacting behavior in the process chamber by the wire. The abrading element in one embodiment of the invention includes a wire formed of a shape memory metal, whereby deformation of the wire occurs during its driven movement, e.g., as it engages the gas-contacting surface of the process chamber, but in which the original shape of the wire is recovered when the movement of the wire is terminated.

The abrading element can be non-linear during repose and/or translational movement, as appropriate. In some applications, an initially straight wire can curve and deform in engagement of the wall surface of the process chamber, to exert the appropriate abrading action on such wall surface. Alternatively, a wire can be employed in which at least part of the length of the wire has a looped, kinked, curled or other conformational character in repose, and is of corresponding or different form during motion in contact with the wall surface.

Although the abrading element can comprise a unitary strand or filament, and such is a preferred form of the wire, the abrading element also can be constituted by an array of sub-filaments, as a brush or rope element, or the abrading element can be formed with a main wire or filament element from which extend branches or extension members, e.g., in a dendritic fashion, whereby extended area contact is made by the abrading element with the particulate-susceptible surface of the process chamber. Additionally, the abrading element can be formed with abrading contact enhancement members on or secured to the wire or other core element, or the abrading element can be treated or processed to enhance its form for improved removal of particulates from the wall surface of the process chamber, such as a wire that is roughened or knurled so that it is able to slough solids off the wall surfaces of the process chamber in a highly effective manner. As a still further alternative, the abrading element can comprise a chain or other linked array or sequentially coupled segmented article.

As used herein, the term “process chamber” is intended to be broadly construed to refer to any structure including a gas-contacting surface that at least partially bounds or encloses a gas flow path along which is flowed a gas that contains or is susceptible to the formation or presence of surface-adherent particulates therein.

The process chamber can therefore comprise a vessel, canister, container, manifold, plenum, piping, conduit, flow circuitry or other structure in which gas contacts the gas-contacting surface.

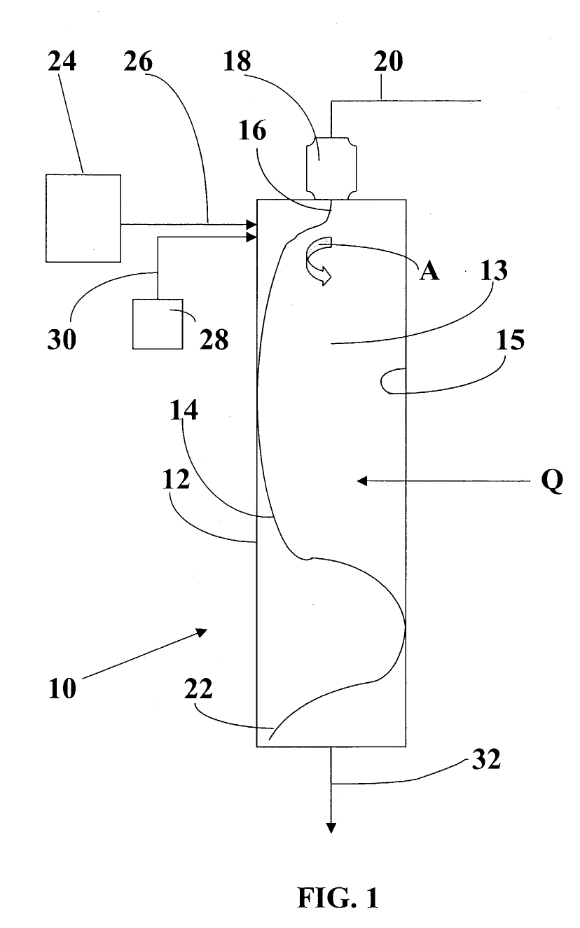

FIG. 1 is a schematic representation of a process system 10 according to one embodiment of the invention.

The FIG. 1 system 10 includes a process chamber 12 enclosing an interior volume 13 therein bounded by the interior wall surface 15 of the chamber. Disposed in the interior volume 13 is a freewire element 14 having a lower free end 22 and an upper end 16 that is coupled to the drive motor 18. The drive motor 18 is energized by power supply line 20 joined to a suitable power supply (not shown in FIG. 1). The term “freewire” as used herein refers to the fact that the wire is free at one end thereof, and at an opposite end is coupled to a motive driver to enable the wire to be motively driven for abrading contact with wall surface regions of a process chamber.

By such arrangement, the freewire element 14, which is non-linear in conformation and has a length that is greater than the longitudinal dimension of the chamber 12, is motively rotated by the drive motor 18, so that the freewire element 14 is rotationally translated in the direction indicated by arrow A in FIG. 1. The freewire element has a flexible rigidity that permits it to whip regions of the interior wall surface 15 during rotational translation of the freewire element, so as to abradingly contact such interior wall surface regions and scour or slough off any particulate matter that is at rest on such interior wall surface regions.

By repetitive rotational translation thereof by the drive motor 18, the freewire element 14 traverses the interior wall surface 15 of the chamber 12, so that the interior wall surface is maintained free of particulate solids accumulations.

In order to increase the scouring action of the freewire element 14, such element may be coated with an abrasive medium, such as sintered metal powder, ceramic particles, or the like, which increase the shearing action of the freewire element on the interior wall surfaces.

As another expedient, a multiple element array of freewire elements can be employed, each being joined at its upper end to the drive motor 18 and independently contacting different regions of the interior wall surface during the motive translation of the multi-element array.

As a further variation, a main freewire element of the type shown as element 14 in FIG. 1 can be employed, with a multiplicity of subwire branch elements each of which is connected to such main element at a first fixed end and with its other end free-standing in character, so that the subwire branch elements also contact the interior wall surface at different regions during the operation of the motive drive motor, to increase the scrubbing action on the interior wall surface.

In the FIG. 1 embodiment, the oxidation chamber 12 is arranged to receive effluent from semiconductor manufacturing facility 24 in effluent discharge line 26 coupled to the upper end of the chamber 12. Concurrently, oxygen gas or other oxidant (ozone, steam, air, oxygen-enriched air, etc.) is introduced to the chamber 12 from oxidant source 28, coupled to the upper end of the chamber 12 by feed line 30. As a specific example, the effluent can comprise silane, trimethylsilane, tetramethylsilane, octamethylcyclotetrasiloxane (OMCTS), dimethyldimethoxysilane (DMDMOS) and/or 1,3,5,7-tetramethylcyclotetrasiloxane (TMCTS), and the oxidant gas can comprise ozone.

The effluent stream from line 26 thus is mixed with the oxidant from line 30 in the interior volume 13 of the chamber 12. Heat is applied to the effluent/oxidant gas mixture in chamber 12 (as indicated schematically by arrow Q in FIG. 1), e.g., by a circumscribing heating jacket, interiorly disposed heat exchange passages, or other suitable heating means, to maintain appropriate temperature for the oxidation treatment of the effluent. The chamber 12 is sized to provide an appropriate residence time in the chamber for the effluent to be oxidatively treated, to produce an abated effluent stream reduced in oxidizable components, which is discharged from the chamber in discharge line 32.

The discharged stream then can be passed to further disposition, culminating in discharge of gas that is depleted in hazardous and toxic components. The further disposition can involve additional treatment of the effluent stream, recovery of selected component(s) therefrom, solids filtering or collection (e.g., to remove particulates that were prevented from depositing on the interior wall surface 14 of the chamber 12), etc.

As a result of the abrading whipping of the interior wall surface by the freewire element, the interior wall surface of chamber 12 is maintained substantially free of solids deposits, thereby permitting the service life of the chamber between successive maintenance events to be significantly lengthened, so that process uptime is increased, in relation to a corresponding effluent treatment system lacking the surface cleaning capability of the present invention.

While the invention has been described herein in reference to specific aspects, features and illustrative embodiments of the invention, it will be appreciated that the utility of the invention is not thus limited, but rather extends to and encompasses numerous other aspects, features and embodiments. Accordingly, the claims hereafter set forth are intended to be correspondingly broadly construed, as including all such aspects, features and embodiments, within their spirit and scope.

What is claimed is:

1. A process system comprising:
(a) a process chamber arranged for flow of gas therethrough, and including a gas-contacting surface, wherein the gas is susceptible to the presence or generation of particulate solids;
(b) a motive driver arranged to provide a rotational driven movement output; and
(c) a flexible, elongate abrading element, free-ended at a first end thereof and coupled at a second end thereof to the motive driver, for rotational driven movement of the abrading element so that the abrading element engages said gas-contacting surface during said rotational driven movement to abradingly remove particulate solids therefrom.

2. The process system of claim 1, wherein the process chamber is part of a semiconductor manufacturing facility.

3. The process system of claim 2, wherein the process chamber is an effluent abatement chamber of said semiconductor manufacturing facility.

4. The process system of claim 3, wherein the process chamber comprises an oxidative decomposition chamber for oxidative removal of oxidizable components of a gaseous effluent stream of said semiconductor manufacturing facility.

5. The process system of claim 4, wherein said gaseous effluent stream comprises a material that is reactive to form silicon dioxide particles during said oxidative removal.

6. The process system of claim 5, wherein said gaseous effluent stream comprises at least one low k source reagent.

7. The process system of claim 6, wherein said at least one low k source reagent is selected from the group consisting of silane, trimethylsilane, tetramethylsilane, octamethylcyclotetrasiloxane (OMCTS), dimethyldimethoxysilane (DMDMOS) and 1,3,5,7-tetramethylcyclotetrasiloxane (TMCTS).

8. The process system of claim 4, wherein said process chamber is arranged in oxidant-receiving relationship with an oxidant source.

9. The process system of claim 8, wherein said oxidant source comprises a gas supply source of an oxidant gas selected from the group consisting of oxygen, ozone, steam, air, and oxygen-enriched air.

10. The process system of claim 1, wherein said process chamber has a cylindrical conformation.

11. The process system of claim 1, wherein said process chamber comprises a structure selected from the group consisting of vessels, canisters, containers, manifolds, plenums, piping, conduits, and flow circuitry.

12. The process system of claim 1, wherein the motive driver comprises a device selected from the group consisting of electric motors, pneumatically driven motors, hydraulically driven motors, fuel-powered engines, flywheels, armatures, gearing, induction motors, magnetically coupled drivers, generators, and power take-off devices.

13. The process system of claim 1, wherein the motive driver comprises an electric motor.

14. The process system of claim 1, wherein the flexible, elongate abrading element comprises an element selected from the group consisting of wires, fibers, filaments, cords, whips, strands, chains, and ribbons.

15. The process system of claim 1, wherein the flexible, elongate abrading element comprises at least one wire.

16. The process system of claim 1, wherein the flexible, elongate abrading element comprises a single wire.

17. The process system of claim 1, wherein the flexible, elongate abrading element comprises an array of wires.

18. The process system of claim 1, wherein the flexible, elongate abrading element comprises at least one dendritically branched wire.

19. The process system of claim 1, wherein the flexible, elongate abrading element is formed of a material comprising a component selected from the group consisting of metals, metal alloys, plastics, polymeric materials, natural fibers, and composites.

20. The process system of claim 1, wherein the flexible, elongate abrading element is formed of a material comprising a metal.

21. The process system of claim 1, wherein the flexible, elongate abrading element comprises a metal wire.

22. The process system of claim 1, wherein said process chamber comprises a cylindrical reaction vessel, and said flexible, elongate abrading element comprises a wire having a length that is 20-50% greater than the longitudinal dimension of said process chamber.

23. The process system of claim 1, wherein the flexible, elongate abrading element has a linear conformation in repose.

24. The process system of claim 1, wherein the flexible, elongate abrading element has a non-linear conformation in repose.

25. The process system of claim 1, wherein the flexible, elongate abrading element includes a section having a curvate, spiraled, or helical shape.

26. The process system of claim 1, wherein the flexible, elongate abrading element includes a section having a looped, kinked, or curled shape.

27. A method of suppressing solids build-up in a process chamber arranged for flow of gas therethrough, and including a gas-contacting surface, wherein the gas is susceptible to the presence or generation of particulate solids, said method comprising rotationally driving a flexible, elongate abrading element at one end thereof, wherein the flexible, elongate abrading element is free-ended at its opposite end, so that the abrading element engages said gas-contacting surface during rotational driven movement to abradingly remove solids therefrom.

28. The method of claim 27, wherein the process chamber is part of a semiconductor manufacturing facility.

29. The method of claim 28, wherein the process chamber is an effluent abatement chamber of said semiconductor manufacturing facility.

30. The method of claim 29, wherein the process chamber comprises an oxidative decomposition chamber for oxidative removal of oxidizable components of a gaseous effluent stream of said semiconductor manufacturing facility.

31. The method of claim 30, wherein said gaseous effluent stream comprises a material that is reactive to form silicon dioxide particles during said oxidative removal.

32. The method of claim 30, wherein said gaseous effluent stream comprises at least one low k source reagent.

33. The method of claim 32, wherein said at least one low k source reagent is selected from the group consisting of silane, trimethylsilane, tetramethylsilane, octamethylcyclotetrasiloxane (OMCTS), dimethyldimethoxysilane (DMDMOS) and 1,3,5,7-tetramethylcyclotetrasiloxane (TMCTS).

34. The method of claim 30, wherein said process chamber is arranged in oxidant-receiving relationship with an oxidant source.

35. The method of claim 34, wherein said oxidant source comprises a gas supply source of an oxidant gas selected from the group consisting of oxygen, ozone, steam, air, and oxygen-enriched air.

36. The method of claim 27, wherein said process chamber has a cylindrical conformation.

37. The method of claim 27, wherein said process chamber comprises a structure selected from the group consisting of vessels, canisters, containers, manifolds, plenums, piping, conduits, and flow circuitry.

38. The method of claim 27, wherein the flexible, elongate abrading element is rotationally driven by a motive driver comprising a device selected from the group consisting of electric motors, pneumatically driven motors, hydraulically driven motors, fuel-powered engines, flywheels, armatures, gearing, induction motors, magnetically coupled drivers, generators, and power take-off devices.

39. The method of claim 27, wherein the flexible, elongate abrading element is rotationally driven by a motive driver comprising an electric motor.

40. The method of claim 27, wherein the flexible, elongate abrading element comprises an element selected from the group consisting of wires, fibers, filaments, cords, whips, strands, chains, and ribbons.

41. The method of claim 27, wherein the flexible, elongate abrading element comprises at least one wire.

42. The method of claim 27, wherein the flexible, elongate abrading element comprises a single wire.

43. The method of claim 27, wherein the flexible, elongate abrading element comprises an array of wires.

44. The method of claim 27, wherein the flexible, elongate abrading element comprises at least one dendritically branched wire.

45. The method of claim 27, wherein the flexible, elongate abrading element is formed of a material comprising a component selected from the group consisting of metals, metal alloys, plastics, polymeric materials, natural fibers, and composites.

46. The method of claim 27, wherein the flexible, elongate abrading element is formed of a material comprising a metal.

47. The method of claim 27, wherein the flexible, elongate abrading element comprises a metal wire.

48. The method of claim 27, wherein said process chamber comprises a cylindrical reaction vessel, and said flexible, elongate abrading element comprises a wire having a length that is 20-50% greater than the longitudinal dimension of said process chamber.

49. The method of claim 27, wherein the flexible, elongate abrading element has a linear conformation in repose.

50. The method of claim 27, wherein the flexible, elongate abrading element has a non-linear conformation in repose.

51. The method of claim 27, wherein the flexible, elongate abrading element includes a section having a curvate, spiraled, or helical shape.

52. The method of claim 27, wherein the flexible, elongate abrading element includes a section having a looped, kinked, or curled shape.
